(19) United States
(12) Patent Application Publication
(10) Pub. No.: US 2008/0142563 A1
(43) Pub. Date: Jun. 19, 2008

(54) String dispensing device for stapler

(76) Inventors: Hoyt Lynn McBroom, Summerville, SC (US); Phillip Whitney Smith, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/640,759

(22) Filed: Dec. 18, 2006

(51) Int. Cl. B27F 7/17

(52) U.S. Cl. 227/19

(57) ABSTRACT

A string dispensing device for attachment to a stapler includes: (a) a string support container including an open top and a bottom container wall, the bottom container wall comprising a central container aperture; (b) a fixed string dispensing arm including a first end portion attached to the string support container; (c) an adjustable stapler attachment mechanism attached to a second, opposite end portion of the string dispensing arm; and (d) a thread guide projecting downwardly from a bottom surface of the string dispensing arm; wherein the string dispensing device does not comprise a motor.

### BACKGROUND OF THE INVENTION

1. Technical Field

The present invention relates to a non-motorized string dispensing device for attachment to a stapler, which is useful for dispensing lengths of string to positions under a staple outlet of the stapler.

2. Background Information

Even on a comparatively windless day, it is difficult to attach felt, also called tar paper or shingle underlayment, to a building roof, walls, or other surface. Once the roofing felt is attached, roof shingles can be attached on top of the felt. Roofers and carpenters sometimes attempt to attach roofing felt with tacks or button caps, but strong winds easily blow and tear the roofing felt off. Lengths of string can be laid along the edges of the felt to hold the felt down. Unfortunately, it takes both hands and a great deal of time for a worker to lay felt on a roof, wall, or other surface, particularly on a roof with a dangerously steep pitch. The worker must intermittently staple each string line down. Wind gusts or inclement weather can further complicate the task.

The present invention is a string dispensing device for attachment to a stapler. The string dispensing device can be attached to the stapler during manufacture of the stapler, or the string dispensing device can be sold separately and easily attached to a conventional stapler by the user. The present invention can be used to quickly apply string tautly to felt on a surface of a roof, walls, or any other suitable surface. Once the task is done, the string dispensing device remains in place on the stapler, or it can quickly be removed from the stapler and stored so that the stapler can be used for its conventional purpose. In the latter case, the string dispensing device can quickly be reattached to the same stapler, or another stapler, when desired.

The present invention benefits end users by decreasing the amount of time workers must spend working on a roof or in another work location, and helping to soundly secure the felt to the roof, wall, or other surface for a longer period of time. The user can easily operate the single unit stapler/string dispensing device with only one hand, leaving the user's other hand free to accomplish other important tasks. The string dispensing device of the present invention facilitates stapling lengths of string tautly to felt on a surface of a roof, wall, or other work surface, allowing the task to be accomplished more accurately and in less time. The term “felt” is meant to include tar paper or underlayment herein.

### BRIEF SUMMARY OF THE INVENTION

The present invention is a string dispensing device for feeding string to a position under a staple outlet of a stapler to which the string dispensing device is attached. The present string dispensing device comprises: (a) a string support container comprising an open top and a bottom container wall, the bottom container wall comprising a central container aperture; (b) a fixed string dispensing arm comprising a first end portion attached to the string support container; (c) an adjustable stapler attachment mechanism attached to a second, opposite end portion of the string dispensing arm; and (d) a thread guide projecting downwardly from a bottom surface of the string dispensing arm; wherein the string dispensing device does not comprise a motor.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of a string dispensing device according to the present invention;

FIG. 2 is a perspective view of the string dispensing device according to FIG. 1;

FIG. 3 is a front elevational view of a string dispensing device according to the present invention;

FIG. 4 is an end elevational view of the string dispensing device according to FIG. 3;

FIG. 5 is a top plan view of the string dispensing device according to FIG. 2;

FIG. 6 is a perspective view of a string dispensing device attached to a stapler according to the present invention;

FIG. 7 is a perspective view of the string dispensing device according to FIG. 6, shown attached to the stapler; and

FIG. 8 is a perspective view of the string dispensing device according to FIG. 6, shown attached to the stapler.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

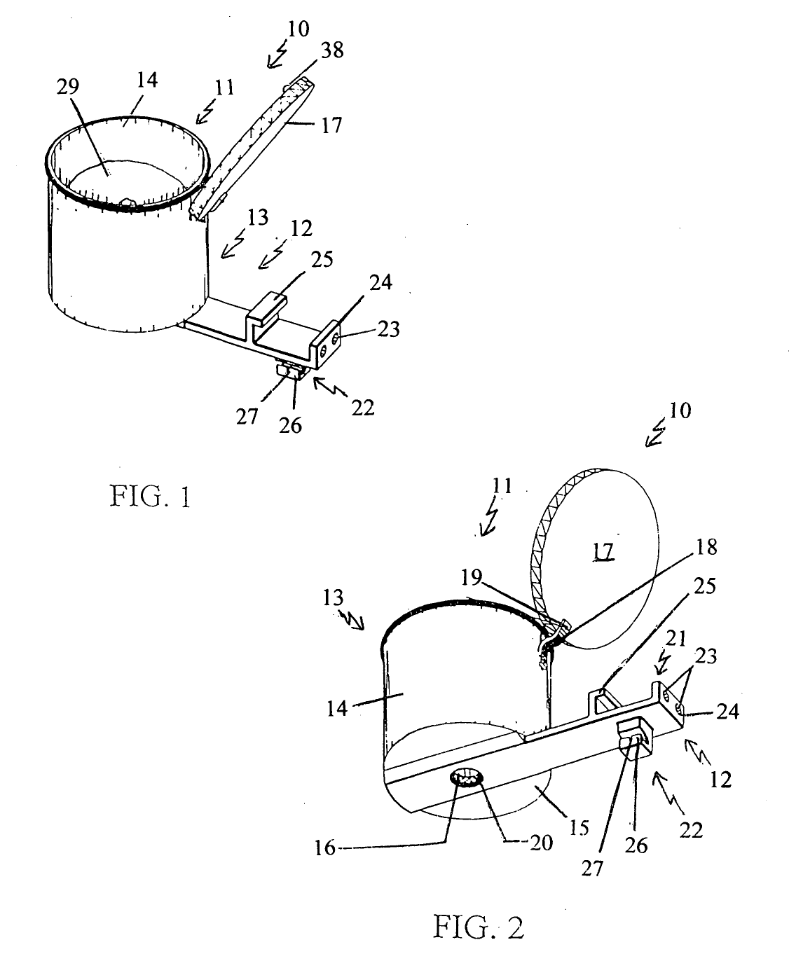

Referring initially to FIG. 1, a non-motorized string dispensing device according to the present invention, generally referred to herein as 10, is attachable to a stapler 30. The stapler 30 is a conventional one, or it may be specially manufactured for attachment to the string dispensing device 10. The stapler 30 may be manually driven or a pneumatically driven stapler gun, as desired. As seen in FIGS. 1, 6, and 7, the staple dispensing device 10 is attached alongside the stapler 30, preferably to the right or left side of the stapler 30, as desired by the user.

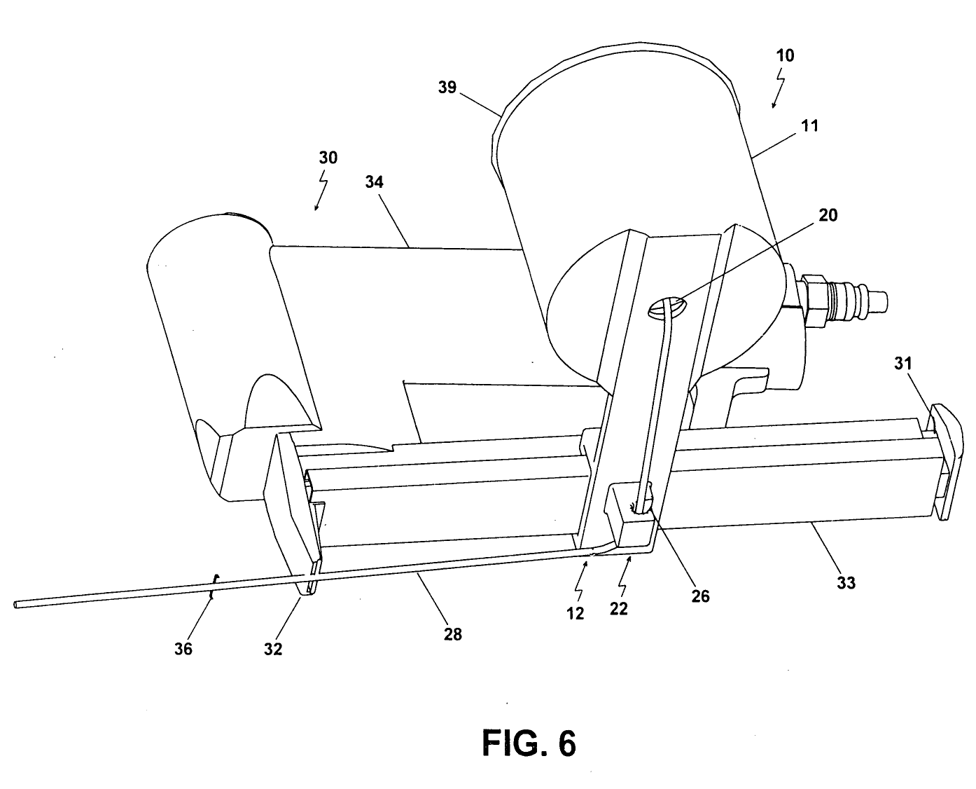

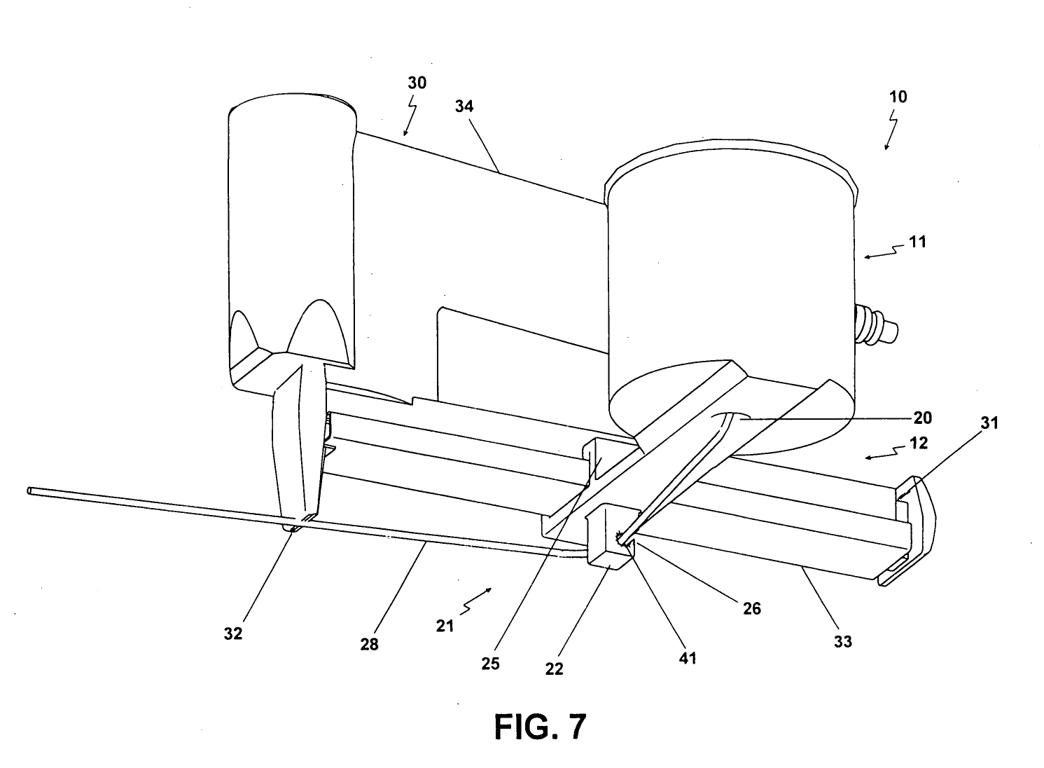

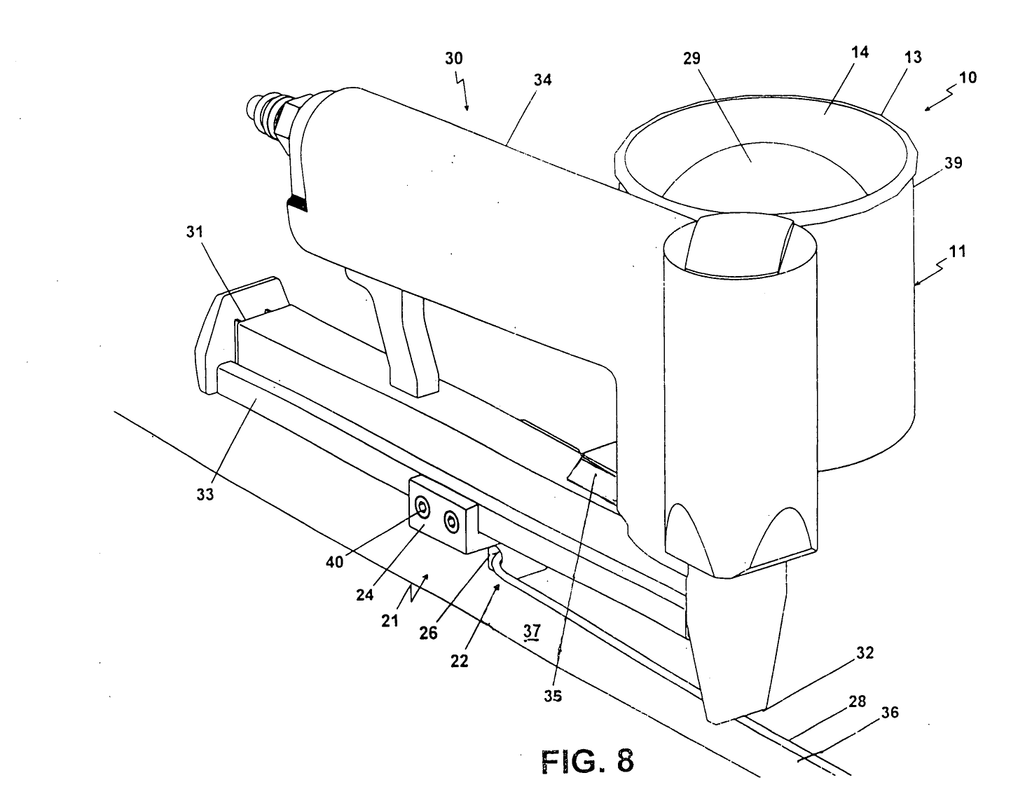

A preferred pneumatic stapler 30 as shown in FIG. 6 includes a staple chamber 31, which supports a re-loadable supply of staples 36. The staple chamber 31 extends through a lower loading arm 33 of the stapler 30 to a staple outlet 32. Staples 36 from the staple chamber 31 are dispensed one by one through the staple outlet 32. The staple outlet 32 preferably extends out an inch or two beyond and generally perpendicular to the lower stapler arm 33. A stapler handle 34 extends above and generally parallel to the lower stapler arm 33, as depicted in FIG. 7. The staple dispensing device 10 is preferably attached to one side of the stapler 30 at a point between the staple outlet 32 and the stapler handle 34, as illustrated in FIGS. 6 and 7. The string dispensing device 10 does not interfere with the reloading of staples 36 into the stapler 30. The string dispensing device 10 is preferably removable from the stapler 30. It can either remain on the stapler 30, even when it is not in use, or it can be removed from the stapler 30 and stored. Removing the string dispensing device 10 from the stapler frees the stapler 30 for use for other, conventional purposes.

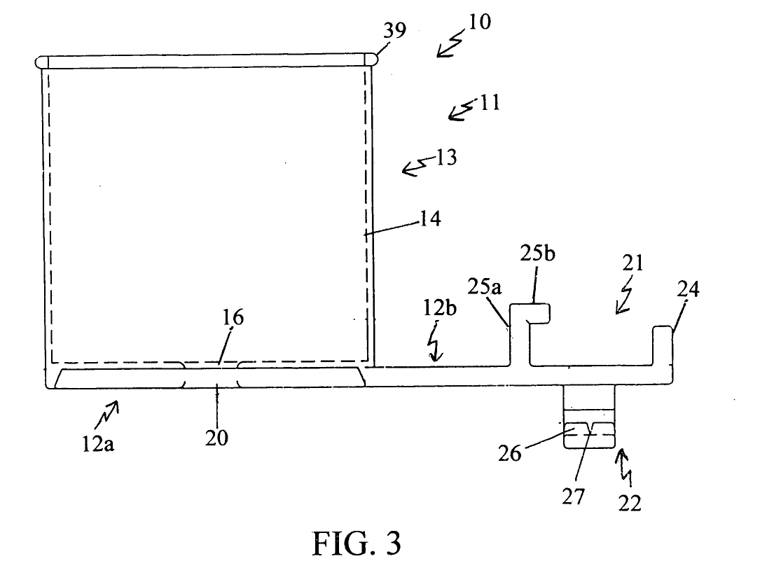

As shown in FIGS. 1 through 4, the string dispensing device 10 includes: (a) a string support container 11 for supporting a ball of string 29; and (b) a string dispensing arm 12. The string used herein is made of any suitable material, such as cotton, polyester, twine, or the like. In the preferred embodiment depicted in FIG. 3, the string support container 11 includes a cylindrical basket 13 with an open top for ease in placing a ball 29 of string in the basket 13 without removing the hand from the stapler 30 with its string dispensing device 10. The string support container 11 preferably includes a substantially cylindrical side container wall 14 attached along its lower edge to a substantially circular bottom container wall 15. The basket 13 or other string support container 11 is sized to closely accommodate a standard size ball 29 of string. It has been found that the strand 28 of string is less likely to become tangled if the new ball of string fits closely within the string support container 11. The basket 13 includes a central container aperture 16 in the bottom container wall 15. The central container aperture 16 is preferably substantially circular in shape.

In use, the user grasps the handle 34 of the stapler 30 in one hand, aligns the staple outlet 32 with the desired location for the staple, and depresses a trigger 35 mounted on the stapler 30 with a finger of the same hand (usually the forefinger). Depressing the trigger 35 with a finger of the same hand causes individual staples 36 to be dispensed from the stapler 30, point down. The user's other hand is free to accomplish other tasks. The string dispensing device 10 is attached to and moves with the stapler 30. With a pneumatic stapler, the staples 36 may be dispensed in rapid succession, as desired by the user, through successive depressions on the stapler trigger 35. The pneumatic stapler typically includes an air hose attached to an air inlet. Between each squeeze of the stapler trigger 35, the user moves the stapler 30 in the desired direction. As the stapler 30 is moved, the strand of string 28 is automatically dispensed from the string support container 11. The successive staples 36 fasten the strand of string 28 in place on the felt 37 on the surface of the roof, wall, or other desired substrate (see FIG. 8). The staples 36 may be dispensed quickly or more slowly using the stapler trigger 35. Thus, two tasks are accomplished (string is dispensed and staples are inserted) with one unit and one hand. In addition to finishing the job more quickly, the job is also accomplished in a safer fashion because the operator is not feeding the string by hand.

As shown in FIG. 2, the string support container 11 preferably includes an openable cap 17 attached at one point to a top edge of the side wall 14 of the basket 13. When the container cap 17 is open, the top of the string support container 11 is open for receiving the ball (or spool) of string. The container cap 17 fits over the top opening of the basket 13 or other string support container 11 so that the ball 29 of string is less likely to inadvertently fall out of the basket. This event would be particularly troublesome where the user is working on a building roof. The container cap 17 is preferably made of a clear plastic material so the amount of string remaining in the string support container 11 can be visually estimated without having to open the string support container 11.

The circular container cap 17 is preferably attached to the side container wall 14 by a flexible cap strap 18. The cap strap 18 is preferably affixed at its opposite ends to the top of the container cap 17 and to the outer face of the side container wall 14, respectively, by cap rivets 19.

The container cap 17 optionally includes a cap clasp 38 at a point on the circumference of the cap opposite the point on the cap where the cap strap 18 is attached. When the container cap 17 is closed, the cap clasp 38 clasps the upper, beaded edge 39 of the container wall 14 opposite the cap strap attachment point. The cap clasp 38 helps to ensure that the container cap 17 will not inadvertently open when the string dispensing device 10 is tipped, and allow the ball 29 of string to roll out of the container 11.

Alternatively, a detachable or elasticized cord can be used across the diameter of the top of the container instead of a cap, or the top inside edge of the string support container may include a flange (not shown). These impede the exit of the ball of string 29 from the container if the stapler 30/string support device 10 is dropped or placed on a slanted surface (such as a pitched roof), for example. In this case, the generally flexible ball of string 29 is squeezed in the user's hand to guide it past the flange, or the cord is detached (where it is detachable) or pushed aside (where it is elasticized) to insert the ball of string 29 into the string support container 11.

As seen in FIGS. 2 and 3, about one third to about one half of the length of the string dispensing arm 12 lies adjacent the bottom container wall 15. This first end portion 12a of the string dispensing arm 12 is preferably attached across the bottom surface of the bottom container wall 15. Thus, the string dispensing arm 12 supports the string support container 11. An arm aperture 20 of the string dispensing arm 12 is aligned with the same-sized container aperture 16 (see FIG. 3). The edges of the container and arm apertures 16, 20 are preferably smooth so the string feed is not impeded. The diameter of the container and arm apertures 16, 20 is substantially greater than the diameter of a strand of string. The width of the string dispensing arm 12 is substantially greater than the diameter of the apertures 16, 20 and substantially smaller than the diameter of the bottom surface of the string support container 11.

Once the string dispensing device 10 is attached to a stapler 30, the user lifts the container cap 17, and inserts a ball of string 29 into the string support container 11. The user feeds the strand of string 28 down through the string support container 11 and the arm and container apertures 16, 20 in the basket 13 and the string dispensing arm 12, respectively. Then the user closes the container cap 17.

The remaining about one half to about two thirds of the string dispensing arm 12 supports the stapler attachment mechanism 21, and a thread guide 22 for guiding the strand of string. As seen in FIGS. 2 and 3, the thread guide 22 projects down from the bottom surface of the string dispensing arm 12. The preferred stapler attachment mechanism 21 is attached to (and may be incorporated into) the upper surface of this second end portion 12b of the substantially planar string dispensing arm 12 above the thread guide 22.

The string dispensing arm 12 preferably detachably attaches to the lower stapler arm 33 between the staple outlet 32 and the stapler handle 34, as illustrated in FIGS. 6 and 7. It has been found herein that feeding the strand 28 of string just below the staple outlet 32 decreases the chances that the string will foul.

As seen in FIG. 3, a preferred stapler attachment mechanism 21 includes an upwardly angled end 24 of the string dispensing arm 12, and a support bracket 25 extending in an upward direction from the string dispensing arm 12. A first leg 25a of the support bracket is substantially parallel to the upwardly angled end 24. The other, second leg 25b of the L-shaped support bracket extends at about a right angle from the end of the first support bracket leg 25a. The second support bracket leg 25b is substantially parallel to the string dispensing arm 12. The angled arm end 24 comprises two spaced apart angled end apertures 40 (see FIG. 3). A set screw 23 is inserted through each angled end aperture 40. The angled end aperture 40 is optionally threaded correspondingly to threads of the set screw 23. The lower stapler arm 33 (or base) of the stapler 30 is insertable in the stapler attachment mechanism 21 between the support bracket 25 and the angled end 24. Once the string dispensing device 10 is in place, the support bracket 25 and the angled end 24 clasp the opposite sides of the lower stapler arm 33, as depicted in FIG. 6-8. The bottom of the lower stapler arm 33 rests on the upper surface of the second end portion 12b of the string dispensing arm between the support bracket 25 and the angled arm end 24. The set screws 23 are then tightened to hold the stapler 30 in place against the support bracket 25, as shown in FIGS. 6-8.

The set screws 23 adjust for fitting the string dispensing device 10 on differently sized staplers 30. The set screws 23 can be screwed in loosely (for wider lower stapler arms) or tightly (for smaller width lower stapler arms). The support bracket 25 can alternatively be slidable along the string dispensing arm 12 so that different widths of lower stapler arms 33 can be accommodated. In this alternate embodiment (not shown), the bottom of the support bracket 25 is set in a track in the upper surface of the string dispensing arm 12.

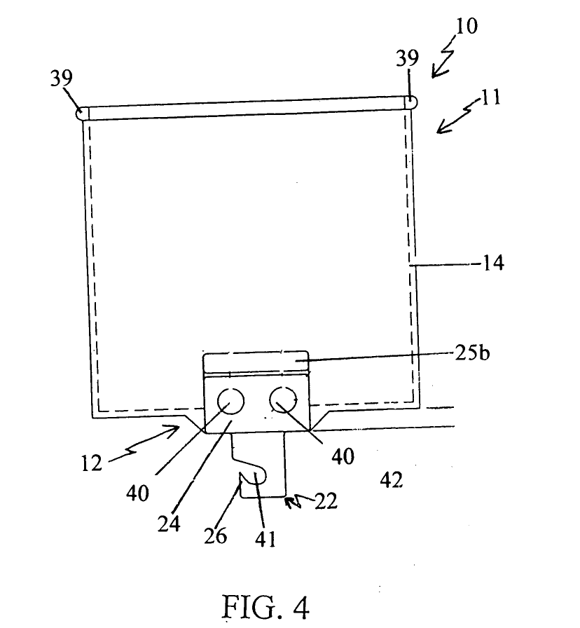

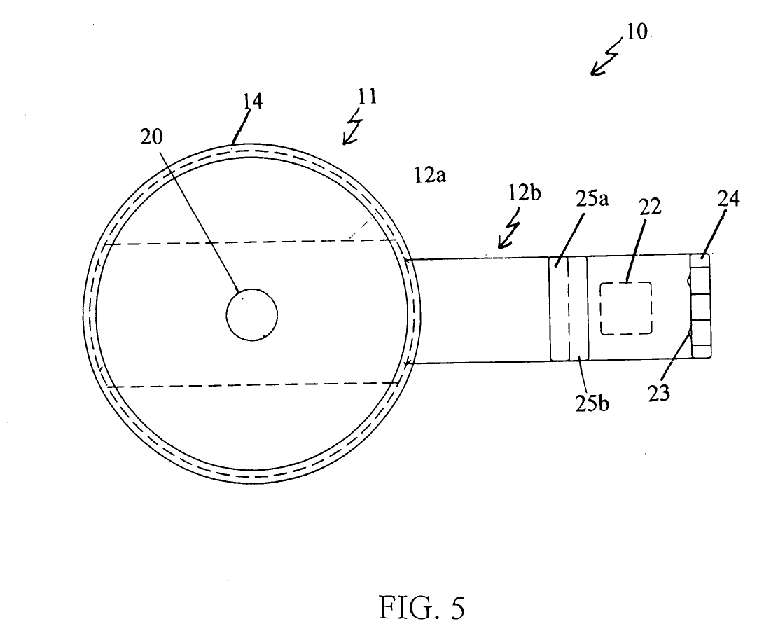

The strand of string from the spool in the string support container 11 extends in a sideways direction toward the stapler 30 and passes through an eye 41 of the thread guide 22. The thread guide 22 is preferably hook-shaped and located below the stapler attachment mechanism 22 (see FIGS. 4 and 7). As illustrated in FIGS. 3 and 4, a sharpened hook end 26 of the thread guide 22 includes a side cutting notch 27 for cutting the strand 28 of string, if desired. The strand 28 of string entering the thread guide 22 forms about a ninety degree angle with the strand as it exits the thread guide, when the string dispensing device 10 is in use (see FIG. 6). From the thread guide 22, the strand 28 of string passes beneath the staple outlet 32. Thus, the strand of string comes into the thread guide 22 from the side (the container 11) and then extends forward under the staple outlet 32 when the string dispensing device 10 is in use.

To cut the string, the operator pulls the strand 28 slightly up out of the thread guide eye 41 and sideways down across the V-shaped cutting notch 27 (see FIGS. 3 and 4). The operator can then begin a new row of string by rethreading the end of the strand 28 through the thread guide eye 41, placing it under the staple outlet 32, and stapling the end of the string to the roof or other substrate. The remainder of the string segment can then be stapled down as described herein in straight line or zigzag fashion, for example.

As the operator pulls the stapler 30 along, the strand 28 of string slowly unwinds from the spool (or ball) in the string support container 11. The strand 28 of string slides easily through the eye 41 of the hook-shaped thread guide 22 (see FIGS. 4 and 7) and is fastened in place on the felt 37 on the surface of the roof or other substrate by staples 36 from the stapler 30 whenever the operator triggers the stapler 30 (see FIGS. 6-8). Each staple 36 from the stapler 30 straddles the string and fastens it to the piece of felt 37 on the roof, wall, or other surface. (The term “felt” herein is meant herein to include tar paper, shingle underlayment, or the like.) Without having to remove his or her hand from the stapler handle 34, the operator dispenses string and staples the string in place at the same time. When the string in the string support container 11 is used up, a replacement supply, usually a new ball or spool, of string 29 can be placed in the string support container 11 and threaded through the container and arm apertures 16, 20 and thread guide 22 as needed.

The hook-shaped thread guide 22 opens to one side of the string dispensing arm 12 and towards the rear of the stapler 30, so the strand of string pulls against the curved back 42 of the thread guide as the stapler 30 and string dispensing device 10 is moved and does not pop out of the eye 41 of the thread guide. As is apparent from FIG. 7, the open thread guide eye 41 does allow the string to be threaded quickly from the rear.

From the foregoing it can be realized that the described device of the present invention may be easily and conveniently utilized as a string dispensing device attachable to a stapler. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 string dispensing device
11 string support container
12 string dispensing arm
13 basket
14 side container wall
15 bottom container wall
16 container aperture
17 container cap
18 cap strap
19 cap rivets
20 arm aperture
21 stapler attachment mechanism
22 thread guide
23 screws
24 angled end
25 support bracket
26 hook end of thread guide
27 thread guide notch
28 strand of string
29 ball of string
30 stapler
31 staple chamber
32 staple outlet
33 lower stapler arm
34 stapler handle
35 stapler trigger
36 staples
37 felt
38 cap clasp
39 beaded container edge
40 angled end apertures
41 thread guide eye
42 thread guide back

What is claimed is:

1. A string dispensing device for attachment to a stapler, the string dispensing device comprising:
(a) a string support container comprising an open top and a bottom container wall, the bottom container wall comprising a central container aperture;
(b) a fixed string dispensing arm comprising a first end portion attached to the string support container;
(c) an adjustable stapler attachment mechanism attached to a second, opposite end portion of the string dispensing arm; and
(d) a thread guide projecting downwardly from a bottom surface of the string dispensing arm;
wherein the string dispensing device does not comprise a motor.

2. The string dispensing device according to claim 1, wherein the string dispensing device is removable.

3. The string dispensing device according to claim 1, wherein the string support container comprises a substantially cylindrical side container wall attached along its lower edge to a substantially circular bottom container wall.

4. The string dispensing device according to claim 2, wherein the first end portion of the string dispensing arm comprises about one third to about one half of the string dispensing arm, the first end portion being adjacent the bottom container wall.

5. The string dispensing device according to claim 3, wherein the first end portion of the string dispensing arm is attached to a bottom surface of the string dispensing container, the string dispensing arm comprising an arm aperture that is aligned with the same-sized container aperture.

6. The string dispensing device according to claim 2, wherein the stapler attachment mechanism comprises an upwardly angled end of the string dispensing arm, and a support bracket extending in an upward direction from an upper surface of the string dispensing arm.

7. The string dispensing device according to claim 6, wherein the angled arm end comprises at least two spaced apart angled end apertures for accommodating set screws.

8. The string dispensing device according to claim 6, wherein a lower stapler arm of the stapler is insertable in the stapler attachment mechanism with the stapler adjacent the support bracket.

9. The string dispensing device according to claim 3, wherein the string support container comprises a cylindrical basket.

10. The string dispensing device according to claim 9, further comprising an openable container cap attached to a top edge of the side container wall.

11. The string dispensing device according to claim 10, wherein the container cap is generally circular and is attached to the side container wall by a cap strap.

12. The string dispensing device according to claim 5, wherein the second end portion of the string dispensing arm comprises a remaining about one half to about two thirds of the string dispensing arm, the second end portion supporting the stapler attachment mechanism and the thread guide.

13. The string dispensing device according to claim 3, wherein the stapler attachment mechanism is attached to an upper surface of the substantially planar string dispensing arm.

14. The string dispensing device according to claim 1, wherein the thread guide is attached to the string dispensing arm below the stapler attachment mechanism, the thread guide comprising a thread guide eye.

15. The string dispensing device according to claim 14, wherein the thread guide is hook-shaped and is open to one side of the string dispensing arm in a direction toward the rear of the stapler when the string dispensing device is attached to the stapler.

16. The string dispensing device according to claim 15, wherein the thread guide further comprises a sharpened hook end and a cutting notch.

17. The string dispensing device according to claim 6, wherein the support bracket comprises two legs, a first leg of the support bracket being substantially parallel to the upwardly angled end, a second leg of the support bracket extending at about a right angle from an end of the first support bracket leg.

18. The string dispensing device according to claim 14, wherein, when the string dispensing device is attached to the stapler and in use, a strand of string from a supply of string in the string support container extends in a sideways direction toward the stapler and passes through the eye of the thread guide.

19. The string dispensing device according to claim 18, wherein the string dispensing device is attached to the stapler adjacent a staple outlet of the stapler.

20. The string dispensing device according to claim 18, wherein the strand of string entering and exiting the thread guide forms about a ninety degree angle when the string dispensing device is in use.
